(19) United States
(12) Patent Application Publication
(10) Pub. No.: US 2002/0184800 A1
(43) Pub. Date: Dec. 12, 2002

(54) Smartcard

(76) Inventor: Richard Benjamin Maselow, Encino, CA (US)

Correspondence Address: RICHARD BINJAMIN MASELOW, #117, 5101 BALBOA BOULEVARD, ENCINO, CA, 91316-2731, US

(21) Appl. No.: 10/166,086

(22) Filed: Jun. 11, 2002

Related U.S. Application Data
(60) Provisional application No. 60/297,318, filed on Jun. 12, 2001.

(51) Int. Cl. B42F 21/00

(52) U.S. Cl. 40/360

(57) ABSTRACT

A manufactured product that is credit card size that provides telephone numbers the end-user or emergency service personnel can use. The product contains information supplied by the end-user (cardholder), specifically a maximum of nine contact names, their relationship to the cardholder and three telephone numbers per contact name. The product provides a method that emergency service personnel can use to identify the name of individual they are directly servicing and gives them telephone numbers to dial to notify persons who are related to the individual.

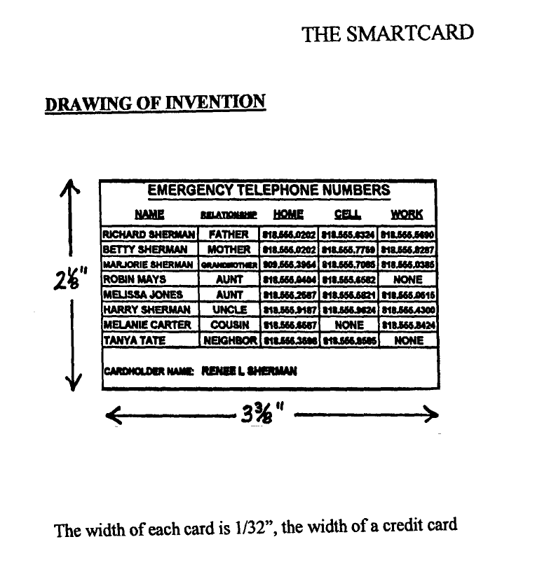

### FIELD & BACKGROUND OF THE INVENTION

The invention relates to providing information, specifically telephone numbers. The invention is particular and unique to each individual that has the product. The product is classified as “Goods in international class 016”, non-magnetically encoded cards. The product is manufactured specifically for displaying telephone numbers.

### BRIEF SUMMARY OF THE INVENTION

The invention is a manufactured product that is credit card size. It is unique to each individual who possesses the product. The invention provides emergency telephone numbers that are selected by the consumer and unique to the consumer.

### BRIEF DESCRIPTION OF DRAWING

The invention is credit card size: 2⅛″ in height; 3⅜″ in length and 1/32″ in width. See attached drawing of invention.

### DETAILED DESCRIPTION OF THE INVENTION

The invention is a manufactured product that is credit card size (2⅛″×3⅜″×1/32″). The invention contains information that is unique to each person possessing the product. The invention contains telephone numbers that are supplied and pertinent to each person who purchases the product, i.e. the “cardholder”. The product contains emergency telephone numbers, selected by the purchaser/consumer, which may be dialed in case the cardholder is involved in an accident. The product contains a maximum of nine contact names, their relationship to the cardholder and three telephone numbers per contact name.

### DETAILED DESCRIPTION OF THE INVENTION (cont)

The invention is manufactured in two methods.

1) Information is on 24# paper and then laminated in 10 mil pouches using a heat pouch-laminating machine.

2) Information is printed on 10 mil through 30 mil PVC material using a card printer machine.

The invention provides a method for quick access to telephone numbers.

The invention can also be used in emergency situations if the cardholder is involved in an accident and possibly unconscious; emergency service personnel such as highway patrol, police, and paramedics can use the invention to identify the name of individual they are directly servicing and gives them telephone numbers to dial to notify persons who are related to the individual.

I claim:

1. A method of quickly accessing telephone numbers.

2. A method that emergency service personnel can use to identify the name of the person they are directly servicing.

3. A method that emergency service personnel can use to contact and notify persons that are related to the person they are directly servicing.
